(19) United States
(12) Patent Application Publication
(10) Pub. No.: US 2011/0028667 A1
(43) Pub. Date: Feb. 3, 2011

(54) Copolymer and Ophthalmological Composition

(76) Inventors: Helmut Ritter, Wuppertal (DE); Daniel Schmitz, Koln (DE); Juergen Nachbaur, Berlin (DE)

Correspondence Address: FITCH EVEN TABIN & FLANNERY, 120 SOUTH LASALLE STREET, SUITE 1600, CHICAGO, IL, 60603-3406, US

(21) Appl. No.: 12/746,895

(22) PCT Filed: Dec. 5, 2008
(86) PCT No.: PCT/EP08/66904

§ 371 Date: Sep. 20, 2010

(30) Foreign Application Priority Data
Dec. 11, 2007 (DE) 10 2007 059 470.6
Aug. 19, 2008 (DE) 10 2008 038 390.2

(51) Int. Cl. C08F 224/00

(52) U.S. Cl. 526/270

(57) ABSTRACT

The invention relates to a copolymer, which includes 20 to 95 percent by weight, based on the total weight of the copolymer, of structural units derived from at least one hydrophilic monomer, and 5 to 80 percent by weight, based on the total weight of the copolymer, of structural units derived from at least one monomer according to the general formula I

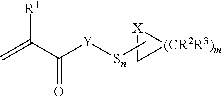

wherein R¹, R² and R³ each independently of each other denote hydrogen or alkyl-, Y: denotes O or NR⁴ with R⁴ selected from hydrogen or alkyl-, X: denotes O, S, SO or SO₂, S denotes a structural unit selected from CHR⁵ or (CHR⁵CHR⁵O)ᵢCH₂, wherein all of the R⁵ each independently of each other denote hydrogen or alkyl-, n and i independently of each other denote an integer between 1 and 10 and m denotes an integer between 2 and 6, and wherein the copolymer has a water content from 1 to 59 percent by weight based on the total weight of the copolymer. Furthermore, the invention relates to an ophthalmologic composition.

### TECHNICAL FIELD

The present invention relates to a copolymer, which is suitable for producing ophthalmic lenses and in particular intraocular lenses and ophthalmic implants. Furthermore, the invention relates to an ophthalmologic composition as well as its use, in particular as an eye implant (intraocular lens).

### PRIOR ART

It is known to form intraocular lenses (IOL), which usually include an optic and a non-optic part, one-piece or multi-piece. In one-piece intraocular lenses, the optic and the non-optic parts are made of a single material. In multi-piece IOLs, the optic and the non-optic parts can be made of different materials. The non-optic parts are also referred to as haptic parts and serve for attachment.

Intraocular lenses are introduced into the eye. In order to achieve reduction of the length of the incision required for introduction of the intraocular lens into the eye, it is desirable to provide a suitable material as a base material for the IOL, mostly a suitable copolymer, which allows shortening of the incision e.g. due to its flexibility and its properties of deployment. Thus, a copolymer, from which an IOL is provided, should have characteristics advantageous in this respect.

In DE 899 181 08 T2, a one-piece intraocular lens with an optic and a haptic part is proposed, in which the optic and the haptic part are produced from the same copolymer. The copolymer contains a hydrophilic monomer and an alkoxyalkyl methacrylate monomer, wherein the optic part and the haptic part in the one-piece IOL are formed from the same copolymer. The copolymer of this one-piece intraocular lens has a water content of ca. 10 to ca. 38 percent by weight of the total weight of the hydrated copolymer.

In DE 699 181 08 T2, it is proposed that in addition to the already mentioned monomers, not more than 10 percent by weight of a further monomer can be contained in the copolymer such that 90 percent by weight of the dry copolymer are allotted to the hydrophilic monomer in combination with the alkoxyalkyl methacrylate.

The copolymer of DE 899 181 08 T2 is to have an improved foldability. However, in the prior art, there is the need to provide copolymers having a further improved foldability and optimized mechanic properties in combination with an improved compatibility.

Furthermore, it is known that the retina of the eye can be protected from phototoxic influences of radiation in the ultraviolet range (200 nm to 400 nm) and in the violet range of the visible light (400 nm to 440 nm) with the aid of molecular absorbers. Such absorbers can be provided in the optical field for use in intraocular lenses (IOL). Intraocular lenses on the market in particular only partially absorb in the violet light range. With respect to order of magnitude, 25% to 35% of the phototoxic light with a wavelength of 430 nm pass through the conventional lens material.

Studies show that the violet light portion plays a crucial role in the development of an age-related macular degeneration (AMD). It begins with depositions of so-called druses, end products of metabolism (lipofuscins), and can be converted into an areal cell death (geographic atrophy) of the retinal pigment epithelium in the advanced stage.

On the other hand, for the photoreception, in particular for the vision in reduced light conditions (scotopic vision), i.e. in the mesopic and scotopic vision, the transmissibility of the lens material in the blue light spectrum (about 450 nm to 500 nm) is of crucial importance. In this blue wavelength range, as little light as possible is to be absorbed in order to exclude an impairment of the mesopic and scotopic vision. However, IOL on the market have a transmission of only about 70% to 75% in this wavelength range (e.g. at 475 nm).

### PRESENTATION OF THE INVENTION

Thus, it is the object of the present invention to provide a material, which overcomes the disadvantages of the prior art and in particular has an advantageous characteristic profile for intraocular lenses.

According to a first aspect, the technical object of the present invention is solved by a copolymer according to the invention, wherein the copolymer includes:
a) 20 to 95 percent by weight, based on the total weight of the copolymer, of structural units derived from at least one hydrophilic monomer, and
b) 5 to 80 percent by weight, based on the total weight of the copolymer, of structural units derived from at least one monomer according to the general formula I

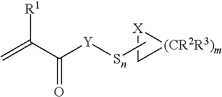

wherein
R¹, R² and R³ each independently of each other denote hydrogen or alkyl-,
Y: denotes O or NR⁴ with R⁴ selected from hydrogen or alkyl-,
X: denotes O, S, SO or SO₂,
S: denotes a structural unit selected from CHR⁵ or (CHR⁵CHR⁵O)ᵢCH₂, wherein all of the R⁵ each independently of each other denote hydrogen or alkyl-,
n and i independently of each other denote an integer between 1 and 10 and
m denotes an integer between 2 and 6, and wherein the copolymer has a water content of 1 to 59 percent by weight based on the total weight of the copolymer. Therein, all of the stereoisomers and racemic mixtures of the monomers a) and b) are basically to be considered as included. Surprisingly, the copolymer of the present invention shows an improved characteristic profile as compared with the copolymers of the prior art. In particular, the copolymer has improved characteristics when it is incorporated into an ophthalmic lens. Such an ophthalmic lens and in particular an intraocular lens can be better folded upon implantation such that the surgical procedure requires a smaller incision before introduction of the intraocular lens into the eye. In addition, the compatibility of such a copolymer in the eye is improved. Furthermore, the copolymer has an improved processability for producing an ophthalmic lens. In comparison with the copolymers of the prior art, the copolymer of the present invention can be mechanically processed in improved manner in order to obtain an intraocular lens.

In an advantageous development of the invention it is provided that the monomer b) has the following structure:

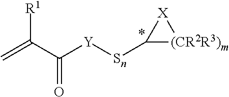

Hereby, the monomer b) additionally has improved characteristics besides the above explained advantages when it is incorporated into an ophthalmic lens.

In a preferred embodiment, the radicals R¹, R², R³ R⁴ and R⁵ are each independently of each other selected from unbranched and/or branched alkyl groups with preferably 1, 2, 3, 4, 5, 8, 7, 8, 9 and/or 10 carbon atoms. Further preferred, the radicals R¹, R², R³, R⁴ and R⁵ are independently of each other a methyl group, ethyl group, n-propyl group, iso-propyl group, n-butyl group, iso-butyl group and/or tert-butyl group.

In a further preferred embodiment, the structural unit S is a methylene group, and in a further preferred embodiment, the structural unit S is a —CH(CH₃)CH₂OCH₂— group.

In a further preferred embodiment, n and i are independently of each other 1, 2, 3, 4, 5, 8, 7, 8, 9 and/or 10. In a further preferred embodiment, m is 2, 3, 4, 5 or 6.

In a further preferred embodiment, the radical R¹ is a methyl group, if the structural unit Y is an O atom. It is further preferred that the radical R¹ represents hydrogen if the group Y is NH.

It is further preferred that 30 to 79 percent by weight, based on the total weight of the copolymer, of structural units are derived from the at least one hydrophilic monomer a) and further preferred 50 to 79 percent by weight of structural units are derived from the at least one hydrophilic monomer a) in the copolymer.

In a further preferred embodiment, based on the total weight of the copolymer, 10 to 79 percent by weight, in particular 21 to 60 percent by weight, preferably 21 to 50 percent by weight and further preferred 21 to 35 percent by weight in the copolymer are derived from the at least one monomer b) according to the general formula I. In particular, based on the total weight of the copolymer, 10 to 35 percent by weight in the copolymer can also be derived from the at least one monomer b) according to the general formula I.

Preferably, the copolymer has a water content from 2 to 50 percent by weight, further preferred from 5 to 40 percent by weight and particularly preferred between 10 and 30 percent by weight based on the total weight of the copolymer.

The proportions of structural units derived from monomers specified within the scope of the disclosure relate to the total weight of the copolymer, and these individual proportions and the water content preferably have to be selected such that 100 percent by weight in total are obtained. In case that further ingredients are contained in the copolymer, these weight proportions and the water content have to be selected such that a total weight of the copolymer including the further ingredients results in 100 percent by weight.

It is further preferred that the hydrophilic monomer a) is a monomer of the general formula II

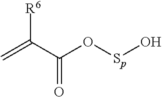

wherein
S: denotes a structural unit selected from CHR⁷ or (CHR⁷CHR⁷0)ₖCH₂, wherein all of the R⁷ each independently of each other denote hydrogen or alkyl-, and
p and k independently of each other denote an integer between 1 and 10. Herein too, all of the stereoisomers and racemic mixtures are to be considered as included.

In a preferred embodiment, the radicals R⁶ and R⁷ are each independently of each other selected from unbranched and/or branched alkyl groups with preferably 1, 2, 3, 4, 5, 8, 7, 8, 9 and/or 10 carbon atoms. Further preferred, the radicals R⁶ and R⁷ are each independently of each other a methyl group, ethyl group, n-propyl group, iso-propyl group, n-butyl group, iso-butyl group and/or tert-butyl group. For R⁶, it is independently thereof particularly preferred that R⁶ is methyl- or H.

For some cases it can be preferred that the copolymer does not include any structural units, which are derived from at least one alkoxyalkyl methacrylate monomer and/or an alkoxyalkyl acrylate monomer.

In a further preferred embodiment, k and p are independently of each other 1, 2, 3, 4, 5, 8, 7, 8, 9 and/or 10.

In a still further preferred embodiment, the hydrophilic monomer of the general formula II is hydroxyethyl methacrylate (HEMA) and/or hydroxypropyl methacrylate (HPMA). Alternatively or additionally, glycerol monomethacrylate can be provided as the hydrophilic monomer.

It is further preferred that the monomer of the general formula I has the following structure

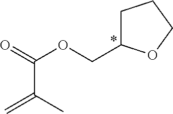

Therein, this monomer (tetrahydrofuran-2-yl)-methylmethacrylate is also known under the common name tetrahydrofurfuryl methacrylate (THFMA). Alternatively or additionally, the position isomer (tetrahydrofuran-3-yl)-methylmethacrylate can also be provided herein.

In a preferred embodiment, the monomers of the general formula I and/or II are present in enantiopure form. Alternatively preferred, the monomers of the general formula I and/or II can be present as racemic mixture.

In a further preferred embodiment, the copolymer includes, at least one or more cross-linkers. As suitable cross-linkers, vinyl monomers or oligomers can be provided, which have two or more polymerizable groups. Hereby, the copolymer can be specifically three-dimensionally cross-linked and the degree of cross-linking can be optimally adjusted depending on the respective purpose of application. For example, ethylene glycol dimethacrylate (EGDMA), trimethylolpropanetri(meth)acrylate, 1,3-glycerindi(meth)acrylate and/or butanedioldi(meth)acrylate can be provided as cross-linkers.

In a further preferred embodiment, the copolymer contains an UV absorber. Therein, organic or inorganic compounds are to be understood by UV absorbers, which at least largely and preferably quantitatively absorb radiation in a wavelength range between 200 nm and 400 nm. A biocompatible UV light protection agent is provided as UV absorber, for which coumarin derivatives, which are optionally linked to one or more acryl or methacryl functions via alkyl spacers, are used.

In a further advantageous development of the invention, it is provided that the UV absorber has the general formula III

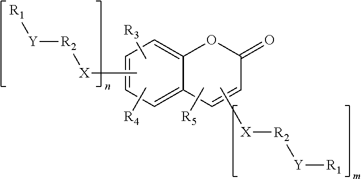

wherein
R1: are acryl or methacryl radicals

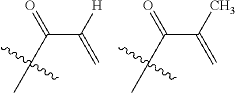

R2: are organic branched and/or unbranched alkyl and/or aryl substituents with up to 30 atoms selected from C, H, Si, O, N, P, S, F, Cl, Br,
R3, R4 and R5: are H or organic branched and/or unbranched alkyl- and/or aryl substituents with up to 30 atoms selected from C, H, Si, O, N, P, S, F, Cl, Br,
X, Y: are O, S, NH or NR, wherein R is an organic branched and/or unbranched alkyl and/or aryl substituent with up to 30 atoms selected from C, H, Si, O, N, P, S, F, Cl, Br; and
n is an integer between 0 and 2 as well as m is 0 or 1, wherein the sum n+m is always greater than or equal to 1. Herein too, all of the stereoisomers and racemic mixtures are to be considered as included. Examples for suitable structures according to formula III are:

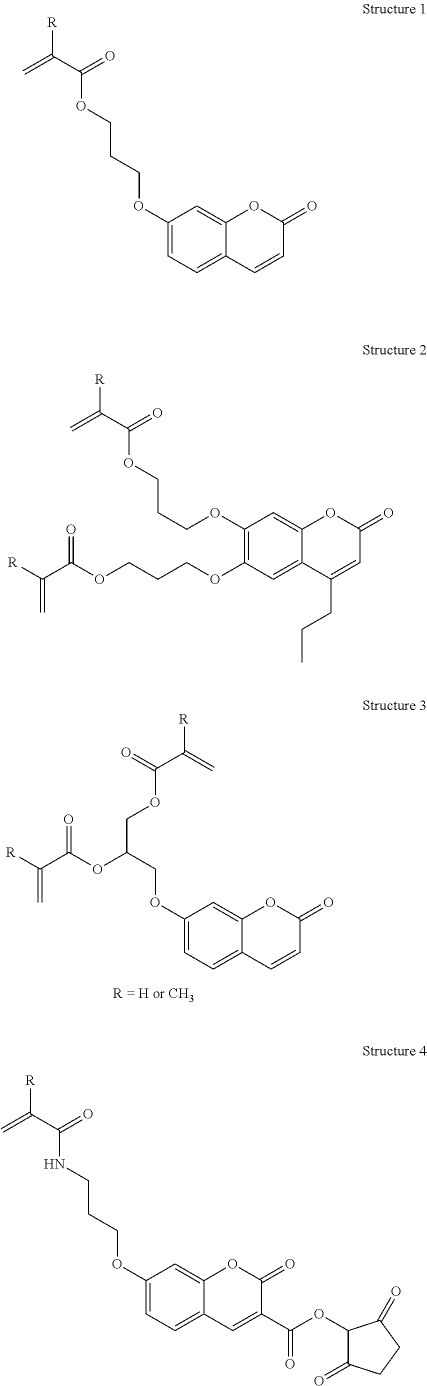

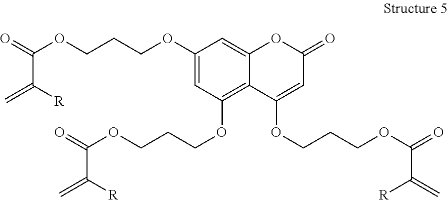

UV absorbers, the basic structure of which is based on the structures 2, 3 and 4, have the advantage that they allow a quantitative incorporation into the lens material due to the presence of plural polymerizable terminal groups, and moreover have cross-linking properties. Thus, in lens manufacture, ideally, the addition of an additional cross-linker can be omitted.

A preferred UV absorber is coumarin-7-propoxymethacrylate having the structure:

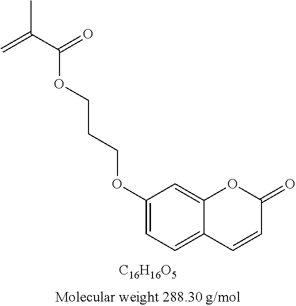

The production of this compound is effected in two steps, wherein the 7-hydroxycoumarin is commercially available:

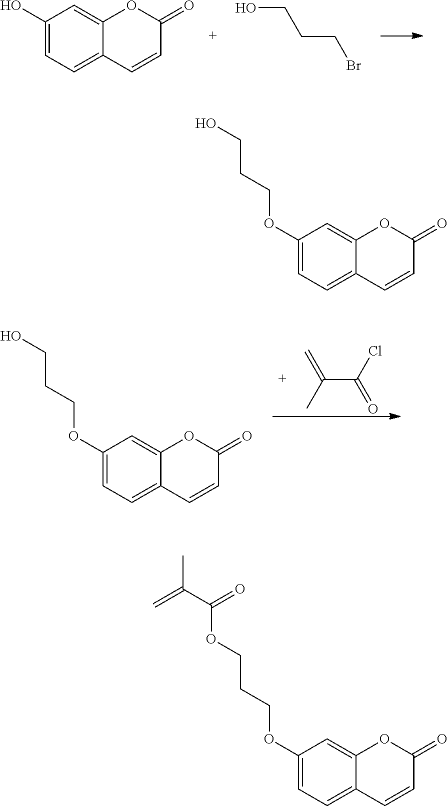

Further embodiments for the UV absorber are compounds, in which a coumarin base body is connected to one or more acryl or methacryl radicals via various spacers. They have the following structure:

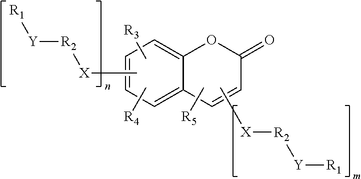

wherein
R1: are acryl or methacryl radicals

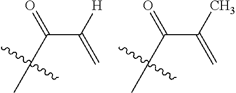

R2: are organic branched and/or unbranched alkyl and/or aryl substituents with up to 30 atoms selected from C, H, Si, O, N, P, S, F, Cl, Br,
R3, R4 and R5: are H or organic branched and/or unbranched alkyl and/or aryl substituents with up to 30 atoms selected from C, H, Si, O, N, P, S, F, Cl, Br,
X, Y: are O, S, NH or NR, wherein R is an organic branched and/or unbranched alkyl- and/or aryl substituent with up to 30 atoms selected from C, H, Si, O, N, P, S, F, Cl, Br, and
n is an integer between 0 and 2 as well as m is 0 or 1, wherein the sum n+m is always greater than or equal to 1. Herein too, all of the stereoisomers and racemic mixtures are to be considered as included.

An example for this is the compound with n=2, m=0, X=O, R2=C₃H₆, Y=O, R1=acryl or methacryl radical, R3=H, R4=H, R5=H in the general formula III.

A further embodiment for an UV absorber is coumarin-6,7-dipropoxymethacrylate. This one too, can be represented in simple synthetic way in a 2-step reaction analogous to the coumarin-7-propoxymethacrylate. The 6,7-dihydroxycoumarin required to this is also commercially available. In this manner, a compound can be produced, in which an additional methacrylate anchor group has been introduced. The linkage of this second anchor group via an alkoxy spacer has only little influence on the spectral properties of the absorber, but allows to employ it also as a cross-linker in the production of the lens material.

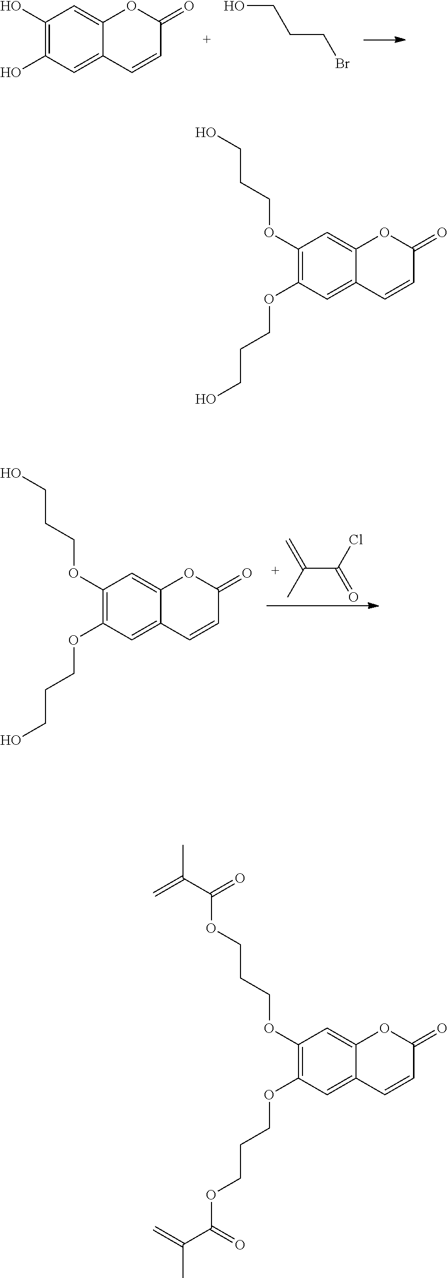

A further example is a structure with n=1, m=0, X=O, R2=—CH₂—CH(OR1)CH₂—, Y=O, R1=acryl or methacryl radical, R3=H, R4=H, R5=H of the general formula III.

A further possibility of producing an UV absorber with two anchor groups results from the use of a branched dihydroxyhalide. If one reacts 7-hydroxycoumarin in a first step with commercially available 3-bromo-1,2-propanediol and subsequently acrylates or methacrylates the resulting alkoxydiol, one obtains a further bifunctional UV absorber.

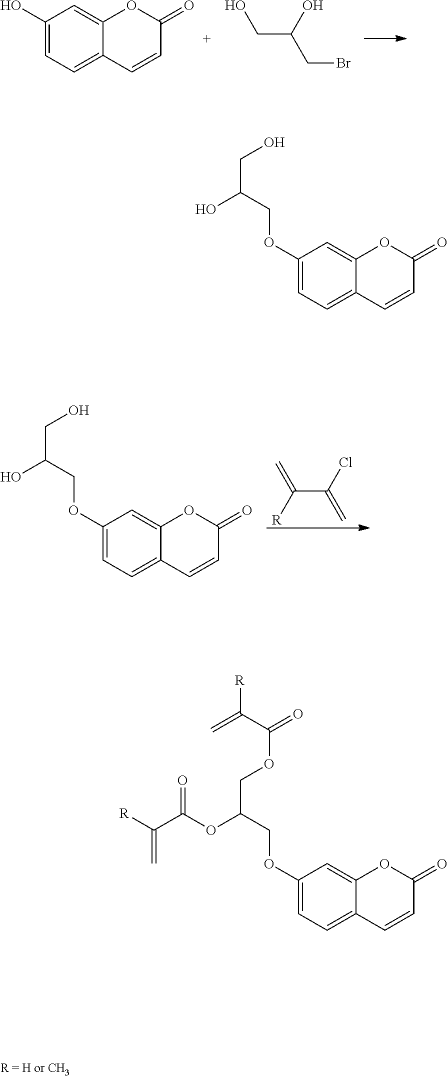

A further example is a structure with n=1, m=0, X=O, R²=—CH₂—CH(OR1)CH₂—, Y=O, R1=methacryl radical, R3=H, R4=H, R5=H of the general formula III.

If one reacts 7-hydroxycoumarin not with acrylic acid or methacrylic acid chloride, but with commercially available glycidyl methacrylate, thus, one obtains a further UV filter in a single reaction step, in which the coumarin base body is separated from the methacrylate radical by an aliphatic chain. By subsequent esterification with methacryloyl chloride, a further methacrylate function can be introduced at the secondary alcohol group.

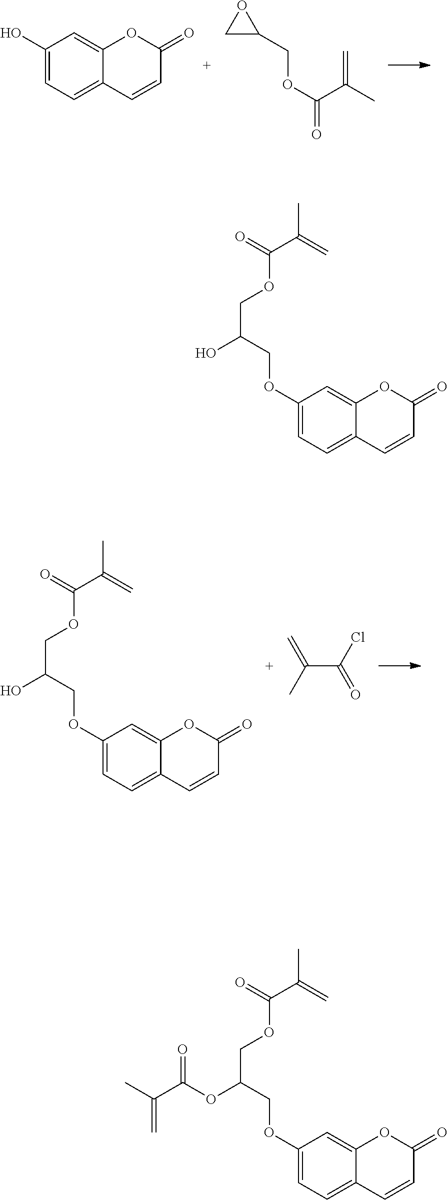

A further example is a structure with n=1, m=0, X=O, R2=C₃H₆, Y=O, R1=acryl or methacryl radical, R3=H, R4=H, R5=C₃H₇ of the general formula III.

Here, R5 is a propyl group having a weak inductive effect (+I effect). The introduction of an additional propyl group into the previously described preferred UV absorber can be managed synthetically without any problems and modifies the spectral properties of the chromophore only to a small extent. If one does not employ 7-hydroxycoumarin in the synthesis, but the also commercially available 7-hydroxy-4-propylcoumarin, one obtains a coumarin derivative after the methacrylation, which differs from the preferred UV absorber by only one propyl side chain.

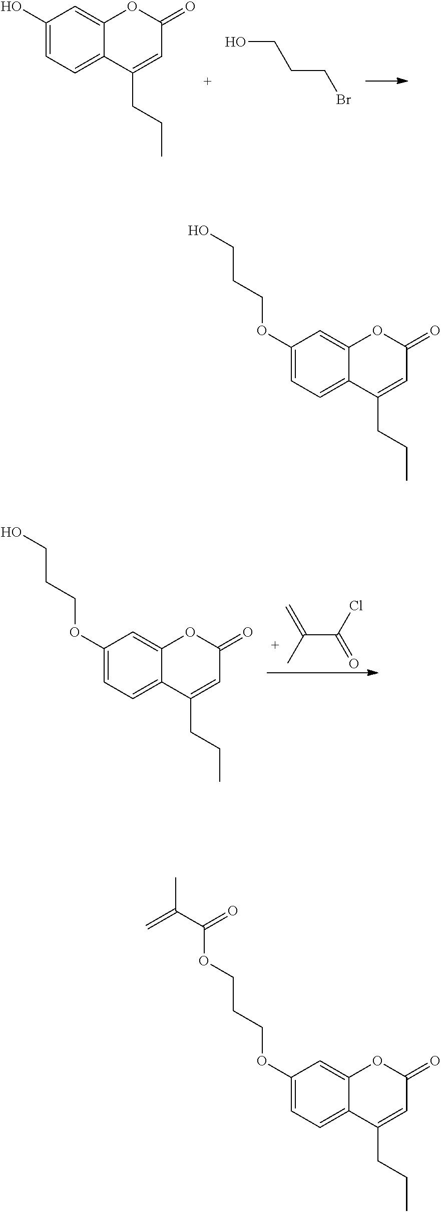

A further example is a structure with n=2, m=1, X=O, R2=C₃H₆, Y=O, R1=acryl or methacryl radical, R3=H, R4=H, R5=H of the general formula III.

A trifunctional UV absorber can also be produced in simple synthetic way. Starting from 4,5,7-trihydroxycoumarin, after the alkoxylation with 3-bromo-1-propanol and subsequent acrylation or methacrylation, one obtains an UV absorber with three anchor groups.

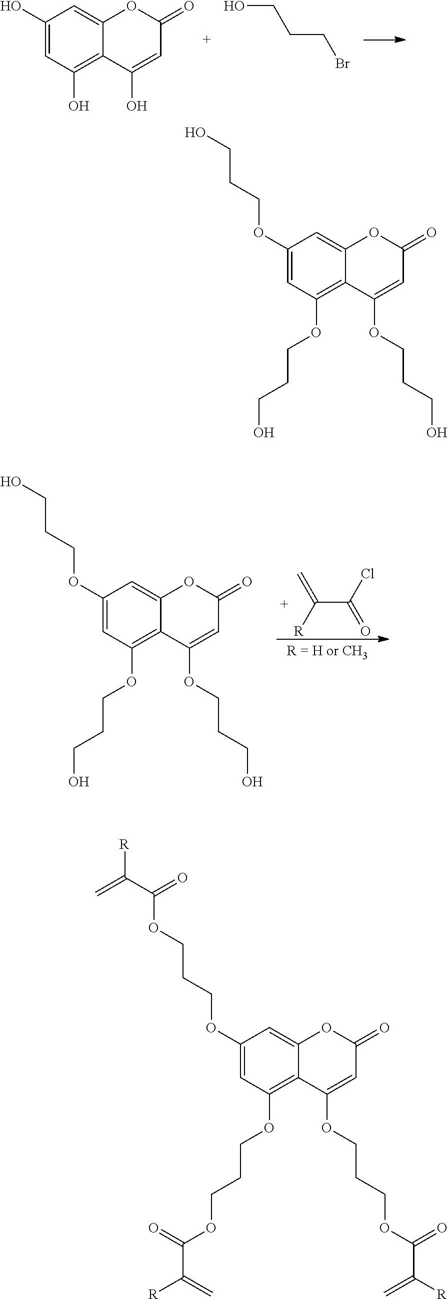

It is further preferred that the copolymer contains a violet absorber (yellow dye). The copolymer preferably contains a violet absorber absorbing and preferably substantially quantitatively or particularly preferred quantitatively absorbing violet light of the wavelengths from about 400 nm to 430 nm.

In a further advantageous development of the invention, it is provided that the violet absorber has the general formula IV

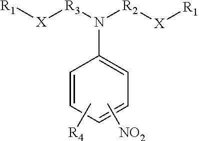

wherein
R1: are acryl or methacryl radicals,
R2: is an organic branched and/or unbranched alkyl and/or aryl spacer group with up to 30 atoms selected from C, H, Si, O, N, P, S, F, Cl, Br,
R3: is an organic branched and/or unbranched alkyl and/or aryl spacer group with up to 30 atoms selected from C, H, Si, O, N, P, S, F, Cl, Br,
R4: is H or an organic branched and/or unbranched alkyl and/or aryl substituent with up to 30 atoms selected from C, H, Si, O, N, P, S, F, Cl, Br, and
X: is O, S, NH or NR, wherein R is an organic branched and/or unbranched alkyl and/or aryl substituent with up to 30 atoms selected from C, H, Si, O, N, P, S, F, Cl, Br.

Herein too, all of the stereoisomers and racemic mixtures are to be considered as included. Examples of corresponding structures are:

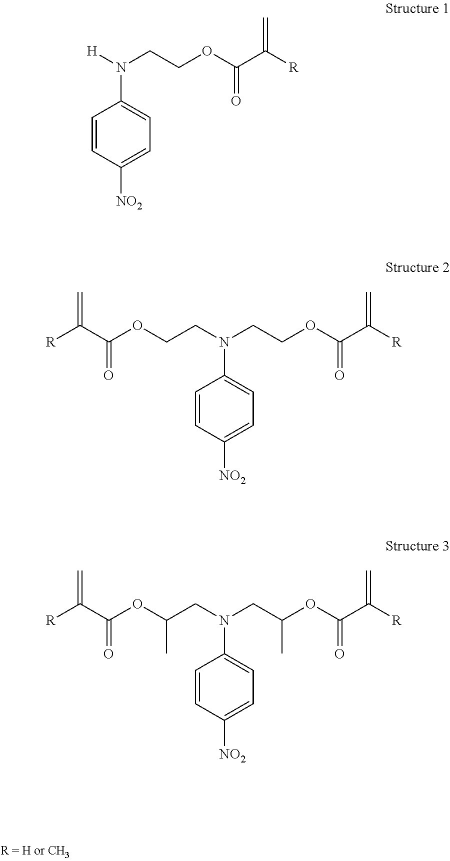

In a further advantageous development of the invention, it is provided that the violet absorber has the general formula V

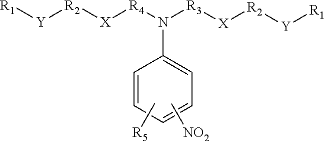

wherein
R1: are acryl or methacryl radicals,
R2: are organic branched and/or unbranched alkyl and/or aryl spacer groups with up to 30 atoms selected from C, H, Si, O, N, P, S, F, Cl, Br,
R3: is an organic branched and/or unbranched alkyl and/or, aryl spacer group with up to 30 atoms selected from C, H, Si, O, N, P, S, F, Cl, Br,
R4: is an organic branched and/or unbranched alkyl and/or aryl substituent with up to 30 atoms selected from C, H, Si, O, N, P, S, F, Cl, Br,
R5: is H or an organic branched and/or unbranched alkyl and/or aryl substituent with up to 30 atoms selected from C, H, Si, O, N, P, S, F, Cl, Br,
X, Y: are O, S, NH or NR, wherein R is an organic branched and/or unbranched alkyl and/or aryl substituent with up to 30 atoms selected from C, H, Si, O, N, P, S, F, Cl, Br.

Herein too, all of the stereoisomers and racemic mixtures are to be considered as included. Examples of corresponding structures (all stereoisomers or racemic mixtures are included) are:

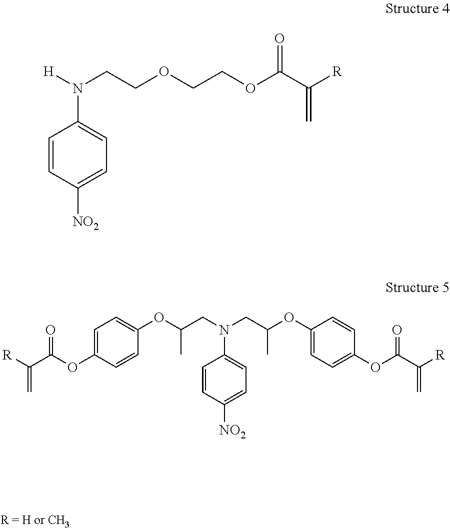

A preferred dye for the violet absorber is N,N-di-2′-ethylmethacrylate-4-nitroaniline having the structure:

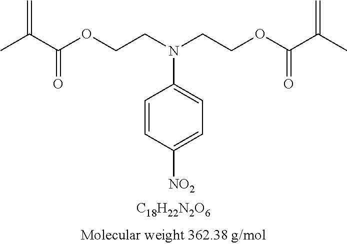

The production of this compound is effected in two steps (according to unexamined application EP 0321891 A2), wherein both educts, both the 4-fluoronitrobenzene and the diethanolamine, are commercially available:

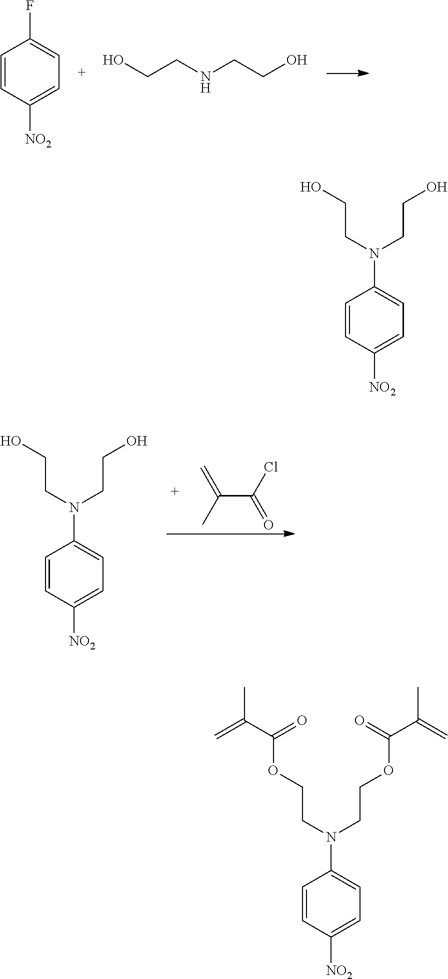

The methacryl radicals serve for covalent bond of the violet filter in the copolymer or a carrier material, in particular lens material based on acrylate. Due to the bifunctionality, the incorporation proceeds quantitatively and thus considerably more effective than in the monofunctional violet filters available on the market.

Further embodiments for the violet absorber are also compounds, in which a nitroanline base body is connected to one or more acryl or methacryl radicals via various spacers.

A further example is a structure with R2 and R3=—CH₂—CH(CH₃)—, X=O, R1=acryl or methacryl radical, R4=H of the general formula IV.

A further embodiment for a yellow chromophore/violet filter is N,N-di-2′-isopropylmethacrylate-4-nitroaniline. This one too, can be produced in simple synthetic way in a 2-step reaction analogous to the diethylmethacrylate-4-nitroaniline. The diisopropanolamine required to this is also commercially available. In this manner, a compound can be produced, which differs from the preferred filter respectively by only one CH₃ group in the side chain. By the positive inductive effect of the methyl groups, this chromophore absorbs slightly shifted to longer wavelengths.

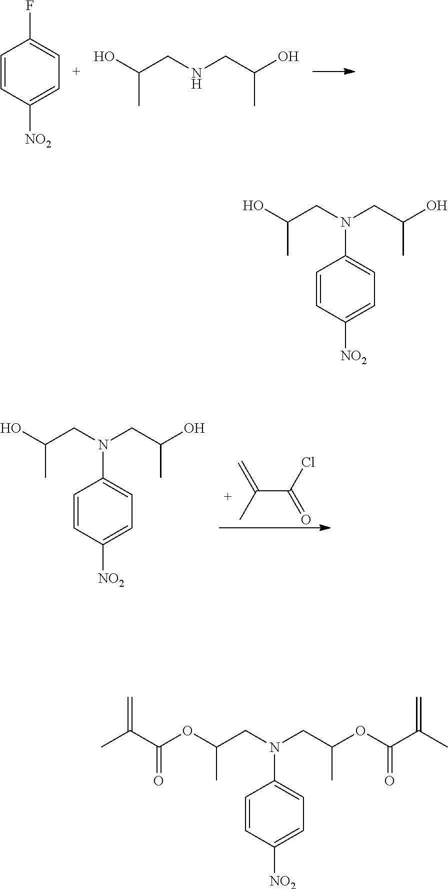

A further example is a structure with R2 and R3=C₂H₄, X=NR, R1=acryl or methacryl radical, R4=H of the general formula IV.

In this example, N,N-dihydroxyethyl-4-nitroaniline is reacted into the diamino derivative by a simple synthetic method. This diamine can be converted into the diamide by a reaction with acrylic acid chloride. The structure of the chromophore remains unchanged and is separated from the acryl amide by two methylene units.

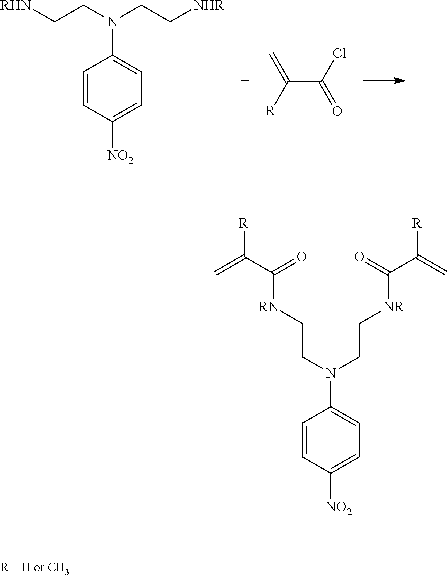

A further example is a structure with R3 and R4=C₂H₄, X=O, R2=—CH₂—CH(OH)CH₂—, Y=O, R1=acryl or methacryl radical, R5=H of the general formula V.

If one reacts N,N-dihydroxyethyl-4-nitroaniline not with acrylic acid or methacrylic acid chloride, but with commercially available glycidyl methacrylate, thus, one obtains a further violet filter in a single reaction step, in which the chromophore is separated from the methacrylate radicals by aliphatic chains.

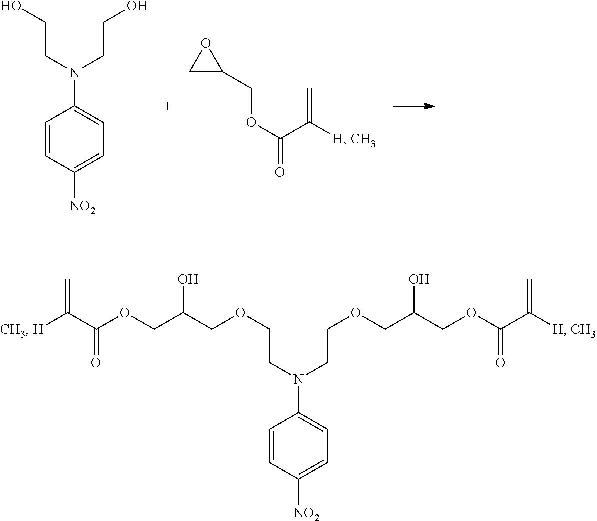

A further example is a structure with R2 and R3=C₂H₄, X=O, R1=acryl or methacryl radical, R4=CH₃ of the general formula IV.

Here, R4 is a methyl group, which has a weak inductive effect (+I effect). The incorporation of an additional methyl group in the previously described preferred violet filter can be managed synthetically without any problems and modifies the spectral properties of the chromophore only to a small extent. If one reacts diethanolamine not with 4-fluoronitrobenzene, but with the also commercially available 2-fluoro-5-nitrotoluene, thus, a nitroaniline is produced, which differs from the preferred violet absorber by just one additional methyl group at the aniline ring. By esterification with acryloylchloride or methacryloylchloride, thus, a further chromophore with the desired spectral properties is obtained.

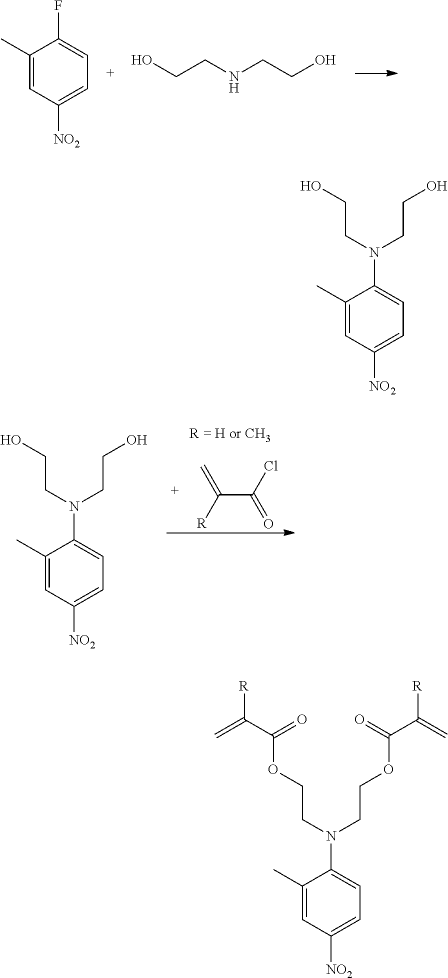

As a biocompatible carrier material, acrylates, in particular with a water content of 1% to 30%, are suitable for the ophthalmologic composition. In the copolymer or in this carrier material, the UV absorber and the violet absorber are covalently bound, respectively. Preferably, the UV absorber is contained in a concentration range of 0.5% to 1.0%. If the ophthalmologic composition is used for an IOL, the respective concentration of the UV absorber is dependent on the respective peak index of refraction (diopter) of the lens. The violet absorber is also covalently bound in the acrylate carrier material or in the copolymer. It can be present in a concentration range of 0.03% to 0.16%. Here too, in use of the ophthalmologic composition for an IOL, the concentration of the violet absorber is directly dependent on the diopter of the lens.

The risk of elution of the absorbers from the carrier matrix does not exist since both the UV absorber according to the invention and the violet filter quantitatively incorporate into the lens material due to the fact that they bear two polymerizable terminal groups.

Suitable biocompatible carrier materials for the UV absorber or the violet absorber are for example hydroxyethyl methacrylate (HEMA), methyl methacrylate (MMA), ethoxyethyl methacrylate (EOEMA), ethoxyethoxy ethylacrylate (EEEA), tetrahydrofufuryl methacrylate (THFMA), tetrahydrofufuryl acrylate (THFA), 2-hydroxypropyl methacrylate (HPMA), 2-hydroxypropyl acrylate (HPA), 2-hydroxyethyl acrylamide, 2-hydroxyethyl methacrylamide, methoxyethyl methacrylate (MOEMA) and methoxyethyl acrylate (MOEA). From the above mentioned substances, copolymers can be produced, possibly using a cross-linker, and used as a carrier material. The percentage composition of the monomers is variable in a wide range. The carrier materials can be adjusted hydrophilic with a water content of for example 1% to 30% or hydrophobic. A limiting factor in hydrophobic, anhydrous polymers is the glass transition temperature. It can be in the range between 0° C. and 11° C. Moreover, it is important that hydrophilic polymers have sufficient flexibility after swelling.

It is particularly preferred according to the invention that at least a portion of the cross-linker or the cross-linkers in the copolymer according to the invention is a violet absorber or an UV absorber.

This has the advantage that not only the amount of the employed various chemicals can be reduced, but also that in this manner the corresponding absorber is a medial component of the copolymer by covalent bond, which minimizes release of the corresponding absorber in many applications.

Preferably, the copolymer has a refractive index of at least 1.3.

A further object of the invention is an ophthalmic lens containing the previously described copolymer. Preferably, the ophthalmic lens is an intraocular lens and/or an ophthalmic implant. Further preferred, the ophthalmic lens can be one-piece or multi-piece. In a further preferred embodiment, the ophthalmic lens is foldable.

A further aspect of the invention relates to an ophthalmologic composition having an UV absorber quantitatively absorbing radiation in the wavelength range of about 200 nm to 400 nm. Further, the ophthalmologic composition includes a violet absorber absorbing violet light of the wavelengths of about 400 nm to 430 nm. Suitable chromophore basic structures of the violet absorber are N-alkoxyacrylated or N-alkoxymethacrylated or even N,N-dialkoxyacrylated or N,N-dialkoxymethacrylated nitroanilines.

As an UV absorber, the ophthalmologic composition includes a biocompatible UV light protection agent, for which coumarin derivatives, which are optionally linked to one or more acryl or methacryl functions via alkyl spacers, are used.

Preferably, the composition is constructed exclusively based on acrylate and/or methacrylate.

The object of the invention is explained in more detail in claims 17 to 43. Suitable UV absorbers of the ophthalmologic composition according to the invention are compounds of the following structures:

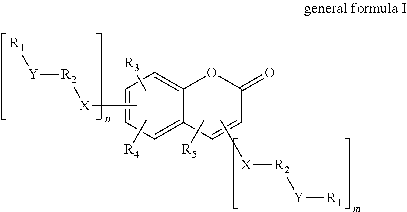

n=0 to 2
m=0 or 1, wherein n+m≧1

### X=O, NH, NR6

### Y=O, NH, NR6

R1: acryl or methacryl radical

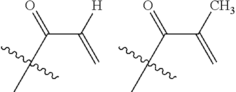

R2: organic alkyl and/or aryl spacer group with up to 30 atoms selected from C, H, Si, O, N, P, S, F, Cl, Br,
R3, R5, R6: H or organic alkyl or aryl group (or combination of both) with up to 30 atoms selected from C, H, Si, O, N, P, S, F, Cl, Br
R4=only if n=0 or 1: H or organic alkyl or aryl group (or combinations of both) with up to 30 atoms selected from: C, H, Si, O, N, P, S, Cl, Br, F.

Examples of corresponding structures (all stereoisomers or racemic mixtures are included) are:

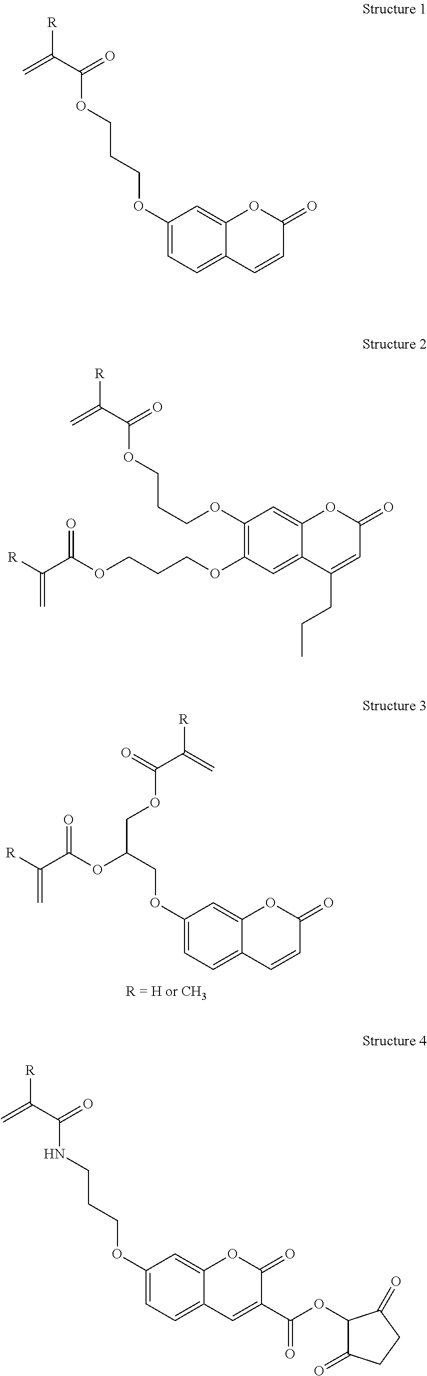

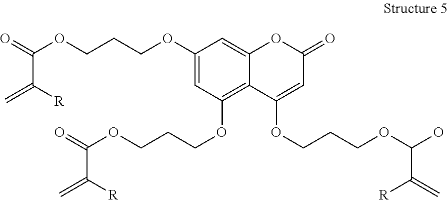

UV absorbers, the basic structure of which is based on the structures 2, 3 and 4, have the advantage that they allow a quantitative incorporation into the lens material due to the presence of plural polymerizable terminal groups, and moreover have cross-linking properties. Thus, in lens manufacture, ideally, the addition of an additional cross-linker can be omitted.

A preferred UV absorber is coumarin-7-propoxymethacrylate having the structure:

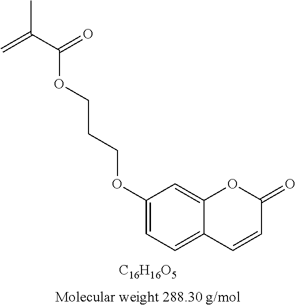

The production of this compound is effected in two steps, wherein the 7-hydroxycoumarin is commercially available:

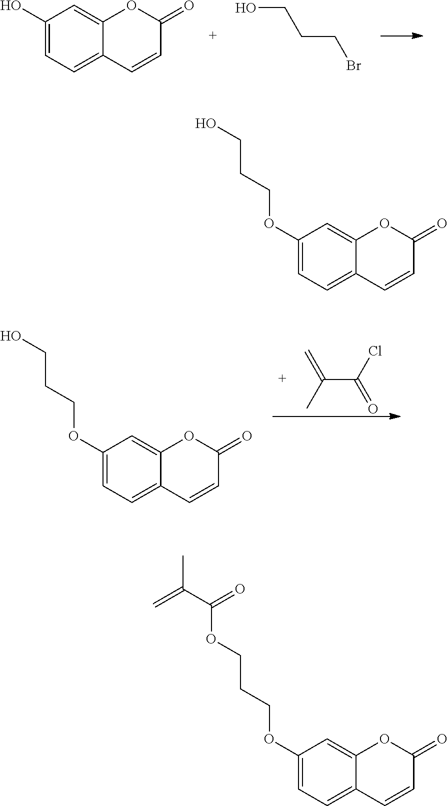

Further embodiments for the UV absorber are compounds, in which a coumarin base body is connected to one or more acryl or methacryl radicals via various spacers. They have the following structure:

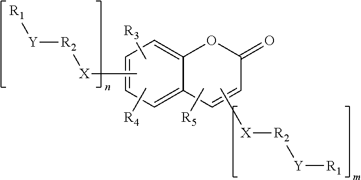

wherein
R1: is an acryl or methacryl radical
R2: organic branched and unbranched alkyl and/or aryl substituents (or combinations of both) with up to 30 atoms selected from C, H, Si, O, N, P, S, F, Cl, Br
R3, R4 and R5: H or organic branched and unbranched alkyl and/or aryl substituents (or combinations of both) with up to 30 atoms selected from C, H, Si, O, N, P, S, F, Cl, Br
X and Y: O, S, NH, NR (R is an organic branched or unbranched alkyl and/or aryl substituent (or combinations of both) with up to 30 atoms selected from C, H, Si, O, N, P, S, F, Cl, Br)
n=0 to 2 as well as m=0 or 1, wherein n+m is always greater than or equal to 1.

### EMBODIMENTS UV ABSORBERS

### Example 1

n=2, m=0, X=O, R2=C₃H₆, Y=O, R1=acryl or methacryl radical, R3=H, R4=H, R5=H in the general formula I.

A further embodiment for an UV absorber in terms of the ophthalmologic composition according to the invention is coumarin-6,7-dipropoxymethacrylate. This one too, can be represented in simple synthetic way in a 2-step reaction analogous to the coumarin-7-propoxymethacrylate. The 6,7-dihydroxycoumarin required to this is also commercially available. In this manner, a compound can be produced, in which an additional methacrylate anchor group has been introduced. The linkage of this second anchor group via an alkoxy spacer has only little influence on the spectral properties of the absorber, but allows to employ it also as a cross-linker in the production of the lens material.

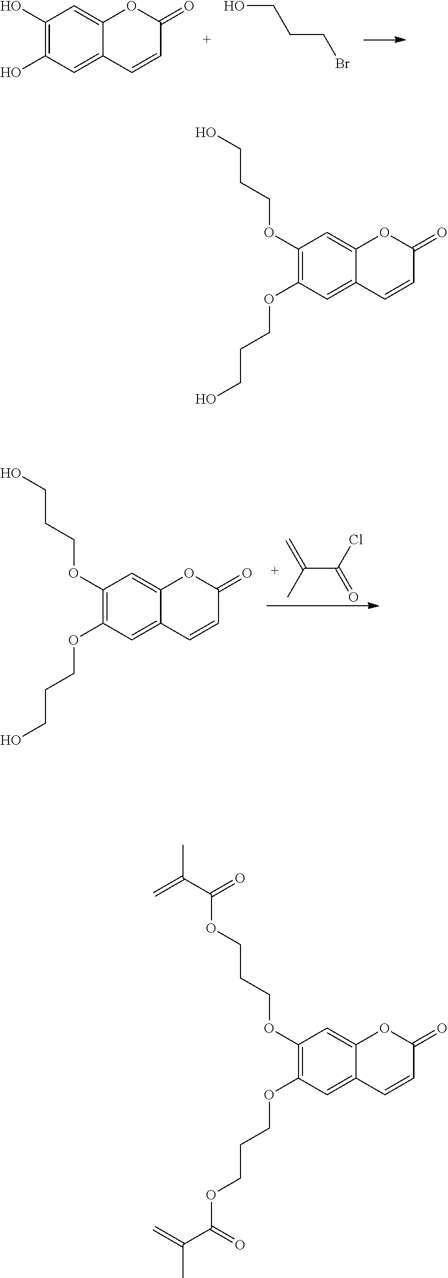

### Example 2

n=1, m=0, X=O, R2=—CH₂—CH(OR1)CH₂—, Y=O, R1=acryl or methacryl radical, R3=H, R4=H, R5=H of the general formula I.

A further possibility of producing an UV absorber with two anchor groups results from the use of a branched dihydroxyhalide. If one reacts 7-hydroxycoumarin in a first step with commercially available 3-bromo-1,2-propanediol and subsequently acrylates or methacrylates the resulting alkoxydiol, one obtains a further bifunctional UV absorber.

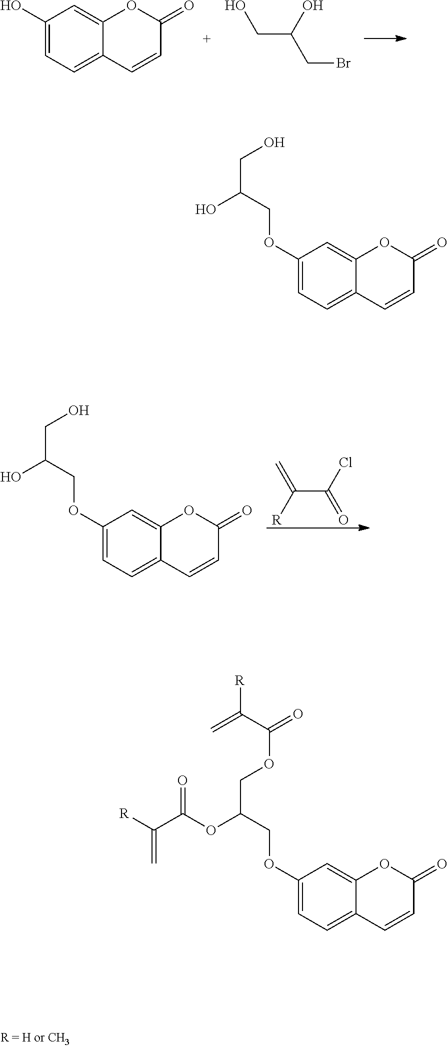

### Example 3

n=1, m=0, X=O, R2=—CH₂—CH(OR1)CH₂—, Y=O, R1=methacryl radical, R3=H, R4=H, R5=H of the general formula I.

If one reacts 7-hydroxycoumarin not with acrylic acid or methacrylic acid chloride, but with commercially available glycidyl methacrylate, thus, one obtains a further UV filter in a single reaction step, in which the coumarin base body is separated from the methacrylate radical by an aliphatic chain. By subsequent esterification with methacryloyl chloride, a further methacrylate function can be introduced at the secondary alcohol group.

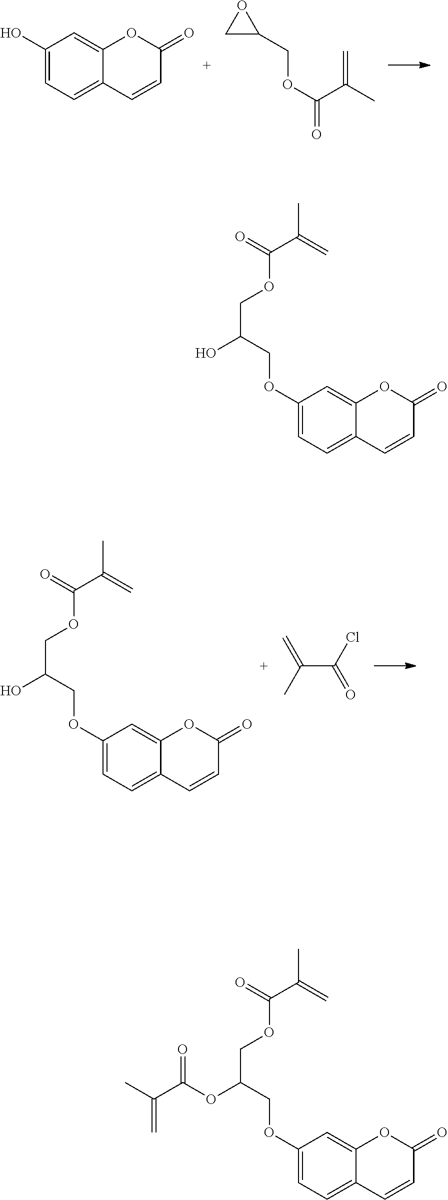

### Example 4

n=1, m=0, X=O, R2=C₃H₆, Y=O, R1=acryl or methacryl radical, R3=H, R4=H, R5=C₃H₇ of the general formula I.

Here, R5 is a propyl group having a weak inductive effect (+I effect). The introduction of an additional propyl group into the previously described preferred UV absorber can be managed synthetically without any problems and modifies the spectral properties of the chromophore only to a small extent. If one does not employ 7-hydroxycoumarin in the synthesis, but the also commercially available 7-hydroxy-4-propylcoumarin, one obtains a coumarin derivative after the methacrylation, which differs from the preferred UV absorber by only one propyl side chain.

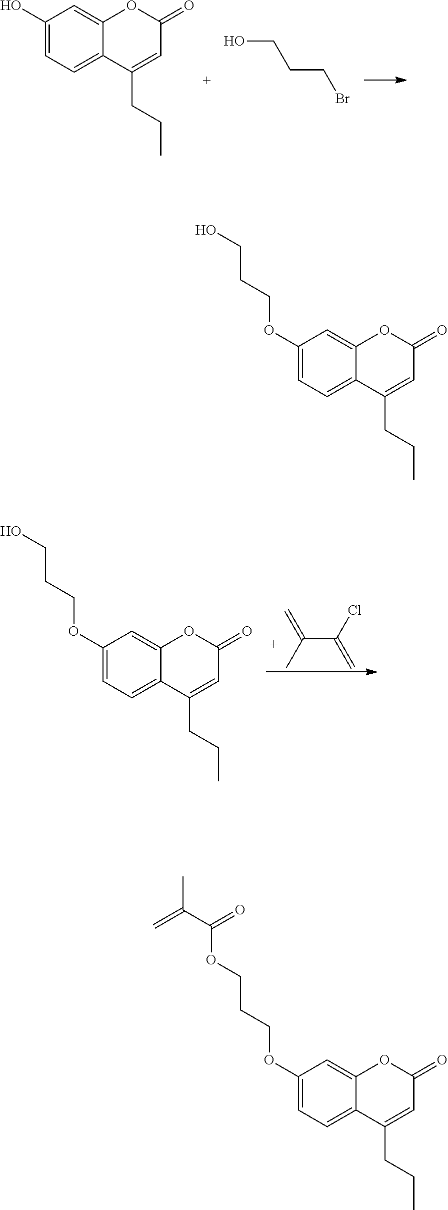

### Example 5

n=2, m=1, X=O, R2=C₃H₆, Y=O, R1=acryl or methacryl radical, R3=H, R4=H, R5=H of the general formula I.

A trifunctional UV absorber can also be produced in simple synthetic way. Starting from 4,5,7-trihydroxycoumarin, after the alkoxylation with 3-bromo-1-propanol and subsequent acrylation or methacrylation, one obtains an UV absorber with three anchor groups.

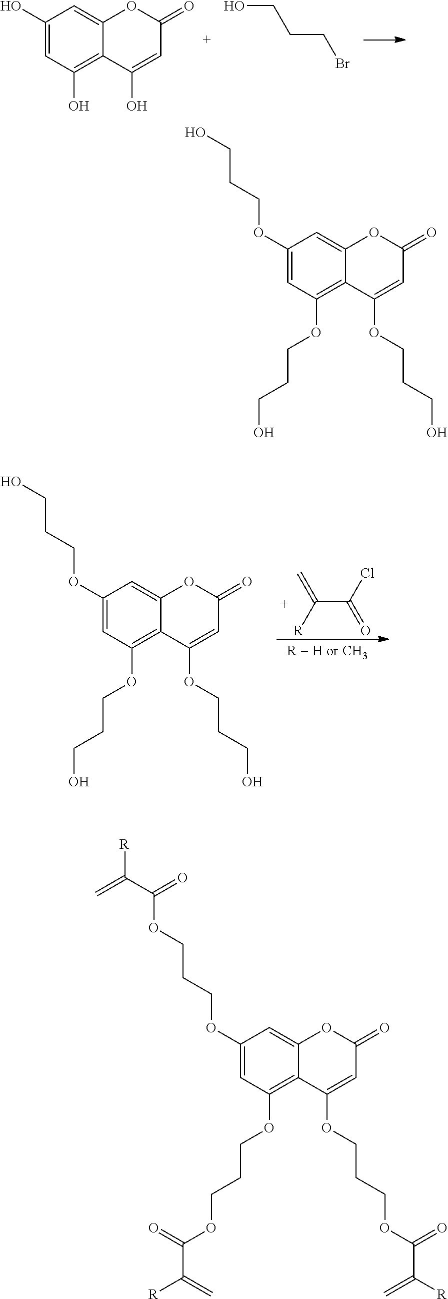

### Violet Absorbers

Suitable violet absorbers of the ophthalmologic composition according to the invention are compounds of the following structures:

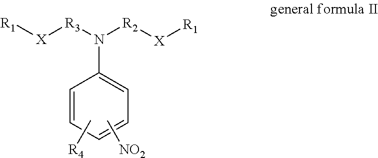

X=O, S, NH, NR (R is an organic branched or unbranched alkyl or aryl substituent (or combinations of both) with up to 30 atoms selected from C, H, Si, O, N, P, S, F, Cl, Br)
R1=acryl or methacryl radical

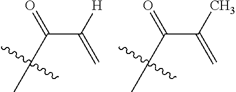

R2=organic branched and unbranched alkyl or aryl spacer group (or combination of both) with up to 30 atoms selected from: C, H, Si, O, N, P, S, Cl, Br, F
R3=organic branched and unbranched alkyl or aryl spacer group (or combination of both) with up to 30 atoms selected from: C, H, Si, O, N, P, S, Cl, Br, F
R4=H or organic branched and unbranched alkyl group with up to 30 atoms selected from: C, H, Si, O, N, P, S, Cl, Br, F or further nitro group, alkoxy group or nitrile group

Examples of corresponding structures (all stereoisomers or racemic mixtures are included) are:

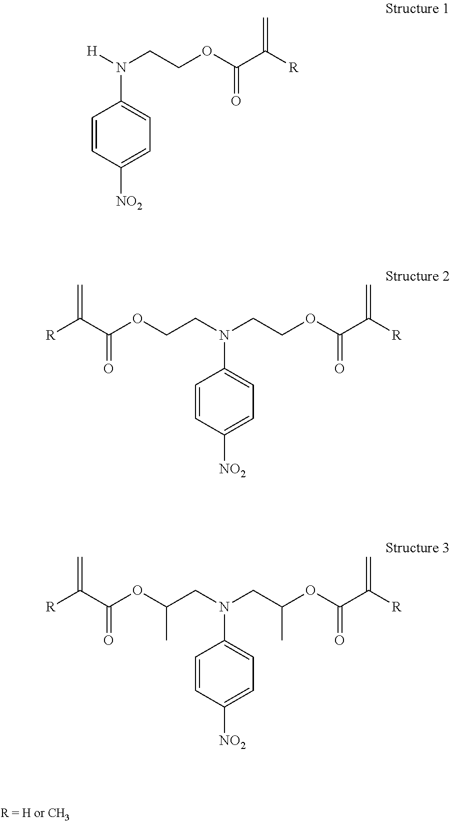

Further, suitable violet absorbers are stereoisomers or racemic mixtures of compounds of the following structures:

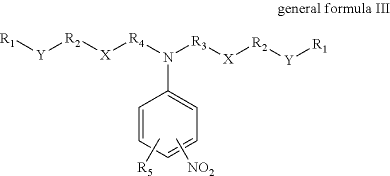

X=0, S, NH, NR (R is an organic branched or unbranched alkyl or aryl substituent (or combinations of both) with up to 30 atoms selected from C, H, Si, O, N, P, S, F, Cl, Br)
Y=O, S, NH, NR (R is an organic branched or unbranched alkyl or aryl substituent (or combinations of both) with up to 30 atoms selected from C, H, Si, O, N, P, S, F, Cl, Br)
R1=acryl or methacryl radical
R2=organic branched and unbranched alkyl or aryl spacer group (or combination of both) with up to 30 atoms selected from: C, H, Si, O, N, P, S, Cl, Br, F
R3=organic branched and unbranched alkyl or aryl spacer group (or combination of both) with up to 30 atoms selected from: C, H, Si, O, N, P, S, Cl, Br, F
R4=organic branched and unbranched alkyl or aryl spacer group (or combination of both) with up to 30 atoms selected from: C, H, Si, O, N, P, S, Cl, Br, F
R5=H or organic branched and unbranched alkyl group with up to 30 atoms selected from: C, H, Si, O, N, P, S, Cl, Br, F or further nitro group, alkoxy group or nitrile group

Examples of corresponding structures (all stereoisomers or racemic mixtures are included) are:

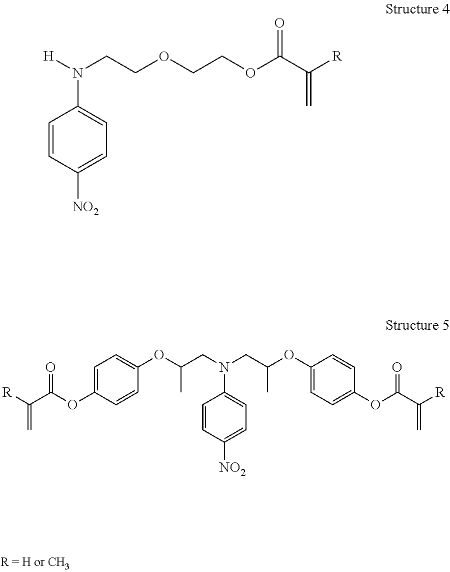

A preferred dye for the violet absorber of the ophthalmologic composition according to the invention is:
N,N-di-2′-ethylmethacrylate-4-nitroaniline
   having the structure:

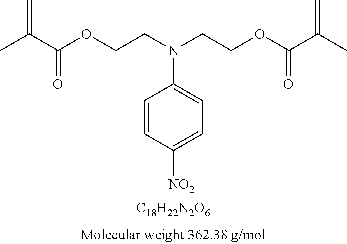

The production of this compound is effected in two steps (according to patent specification EP 0321891 A2), wherein both educts, both the 4-fluoronitrobenzene and the diethanolamine, are commercially available:

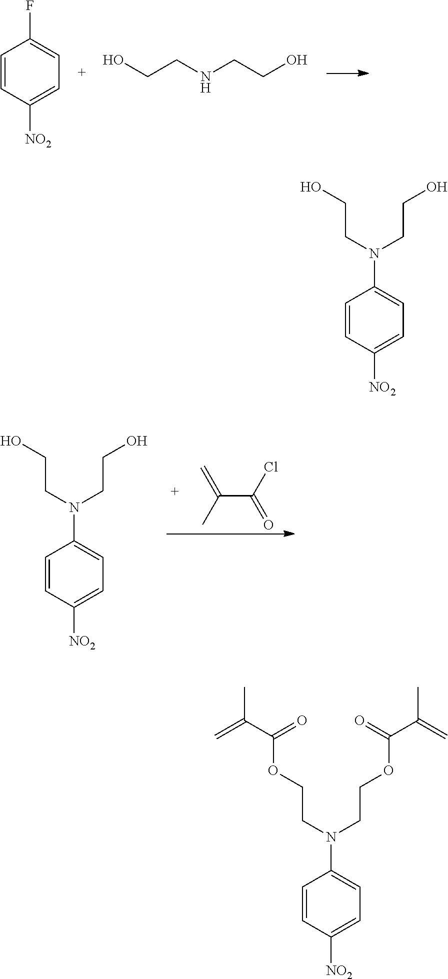

The methacryl radicals serve for covalent bond of the violet filter in the copolymer or a carrier material, in particular lens material based on acrylate. Due to the bifunctionality, the incorporation proceeds quantitatively and thus considerably more effective than in the monofunctional violet filters available on the market.

Further embodiments for the violet absorber are also compounds, in which a nitroanline base body is connected to one or more acryl or methacryl radicals via various spacers.

### Embodiments Violet Absorbers

### Example 1

R2 and R3=—CH₂—CH(CH₃)—, X=O, R1=acryl or methacryl radical, R4=H of the general formula II.

A further embodiment for a yellow chromophore/violet filter is N,N-di-2′-isopropylmethacrylate-4-nitroaniline. This one too, can be produced in simple synthetic way in a 2-step reaction analogous to the diethylmethacrylate-4-nitroaniline. The diisopropanolamine required to this is also commercially available. In this manner, a compound can be produced, which differs from the preferred filter respectively by only one CH₃ group in the side chain. By the positive inductive effect of the methyl groups, this chromophore absorbs slightly shifted to longer wavelengths.

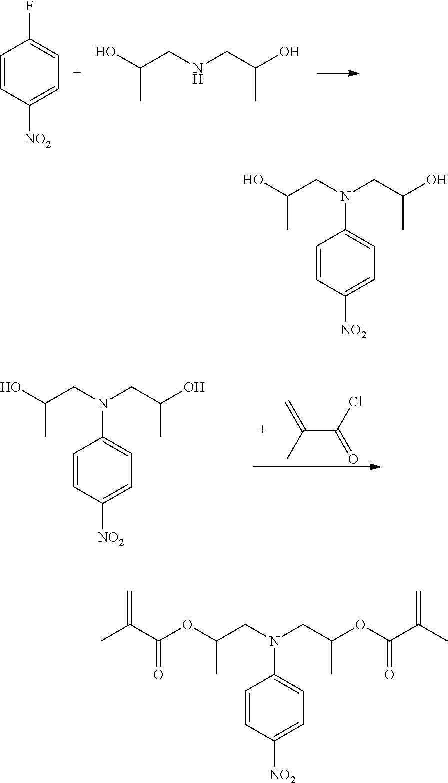

### Example 2

R2 and R3=C₂H₄, X=NR, R1=acryl or methacryl radical, R4=H of the general formula II.

In this example, N,N-dihydroxyethyl-4-nitroaniline is reacted into the diamino derivative by a simple synthetic method. This diamine can be converted into the diamide by a reaction with acrylic acid chloride. The structure of the chromophore remains unchanged and is separated from the acryl amide by two methylene units.

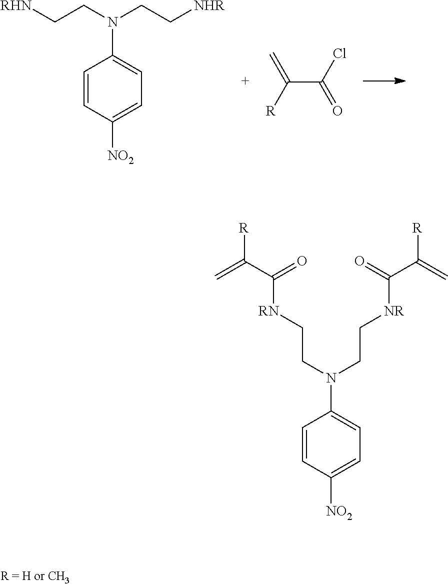

### Example 3

R3 and R4=C₂H₄, X=O, R2=—CH₂—CH(OH)—CH₂—, Y=O, R1=acryl or methacryl radical, R5=H of the general formula III.

If one reacts N,N-dihydroxyethyl-4-nitroaniline not with acrylic acid or methacrylic acid chloride, but with commercially available glycidyl methacrylate, thus, one obtains a further violet filter in a single reaction step, in which the chromophore is separated from the methacrylate radicals by aliphatic chains.

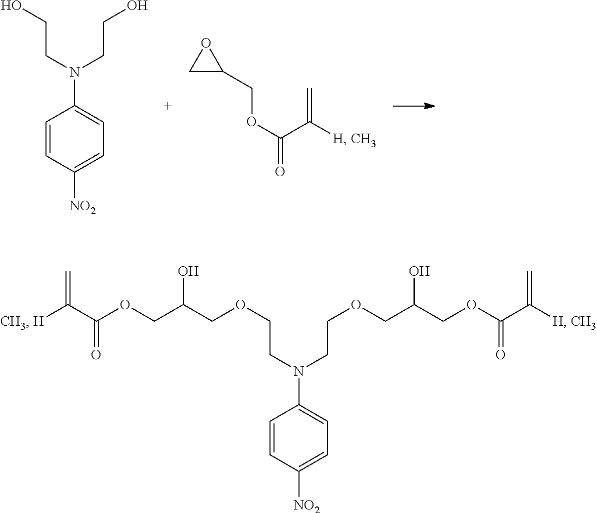

### Example 4

R2 and R3=C₂H₄, X=NR, R1=acryl or methacryl radical, R4=CH₃ of the general formula II.

Here, R4 is a methyl group, which has a weak inductive effect (+I effect). The incorporation of an additional methyl group in the previously described preferred violet filter can be managed synthetically without any problems and modifies the spectral properties of the chromophore only to a small extent. If one reacts diethanolamine not with 4-fluoronitrobenzene, but with the also commercially available 2-fluoro-5-nitrotoluene, thus, a nitroaniline is produced, which differs from the preferred violet absorber by just one additional methyl group at the aniline ring. By esterification with acryloylchloride or methacryloylchloride, thus, a further chromophore with the desired spectral properties is obtained.

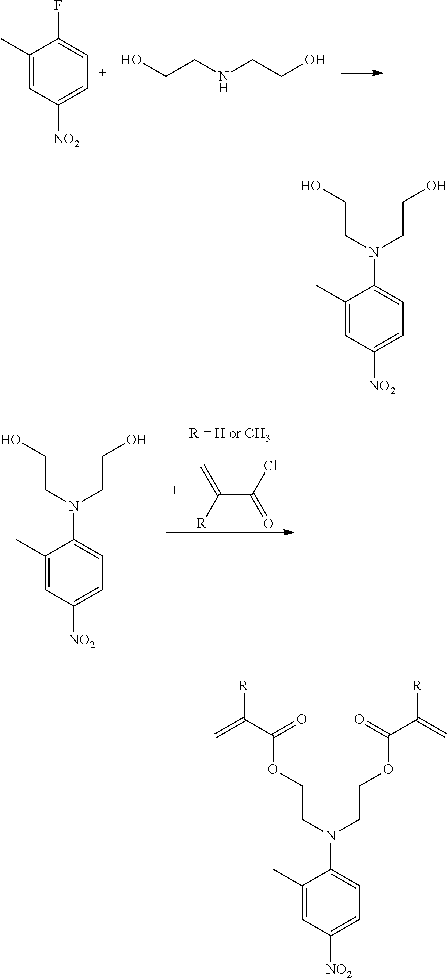

As a biocompatible carrier material, acrylates, in particular with a water content of 1% to 30%, are suitable for the ophthalmologic composition. In the copolymer or in this carrier material, the UV absorber and the violet absorber are covalently bound, respectively. Preferably, the UV absorber is contained in a concentration range of 0.5% to 1.0%. If the ophthalmologic composition is used for an IOL, the respective concentration of the UV absorber is dependent on the respective peak index of refraction (diopter) of the lens. The violet absorber is also covalently bound in the acrylate carrier material or in the copolymer. It can be present in a concentration range of 0.03% to 0.16%. Here too, in use of the ophthalmologic composition for an IOL, the concentration of the violet absorber is directly dependent on the diopter of the lens.

The risk of elution of the absorbers from the carrier matrix does not exist since both the UV absorber according to the invention and the violet filter quantitatively incorporate into the lens material due to the fact that they bear two polymerizable terminal groups.

Suitable biocompatible carrier materials for the UV absorber or the violet absorber are for example hydroxyethyl methacrylate (HEMA), methyl methacrylate (MMA), ethoxyethyl methacrylate (EOEMA), ethoxyethoxy ethylacrylate (EEEA), tetrahydrofufuryl methacrylate (THFMA), tetrahydrofufuryl acrylate (THFA), 2-hydroxypropyl methacrylate (HPMA), 2-hydroxypropyl acrylate (HPA), 2-hydroxyethyl acrylamide, 2-hydroxyethyl methacrylamide, methoxyethyl methacrylate (MOEMA) and methoxyethyl acrylate (MOEA). From the above mentioned substances, copolymers can be produced, possibly using a cross-linker, and used as a carrier material. The percentage composition of the monomers is variable in a wide range. The carrier materials can be adjusted hydrophilic with a water content of for example 1% to 30% or hydrophobic. A limiting factor in hydrophobic, anhydrous polymers is the glass transition temperature. It can be in the range between 0° C. and 11° C. Moreover, it is important that hydrophilic polymers have sufficient flexibility after swelling.

Embodiments of the ophthalmologic composition are the following with quantitative compositions in % by weight

### Embodiment Carrier Materials

### Example 1

### Hydrophobic

EOEMA (ethoxyethyl methacrylate) 85-97% by wt.
MMA (methyl methacrylate) 0-15% by wt.
EEEA (ethoxyethoxy ethylacrylate) 0-5% by wt.
EGDMA (ethylene glycol dimethacrylate) 0-0.7% by wt.
UV absorber 0.1-1.0% by wt.
violet absorber 0.03-0.16% by wt.

### Example 2

### Hydrophilic

HEMA (hydroxyethyl methacrylate) 50-85% by wt.
EOEMA (ethoxyethyl methacrylate) 30-40% by wt.
THFMA (tetrahydrofufuryl methacrylate) 5-20% by wt.
EGDMA (ethylene glycol dimethacrylate) 0-0.7% by wt.
UV absorber 0.1-1.0% by wt.
violet absorber 0.03-0.16% by wt.

For the synthesis of the respective lens materials, first, the monomers are consecutively weighed in a beaker and stirred until a homogenous solution has developed. Thereafter, first, the cross-linker and subsequently the violet as well as the UV absorber are added. With slight heating, it is again stirred until a homogenous solution is obtained.

The mixture respectively resulting is mixed with a suitable initiator and converted into the polymerization shapes (e.g. cups, rod or flat shapes). The polymerization is initiated by heating (60° C. for 12-16 h). After cooling, the polymerizates are removed, optionally post-cured in the compartment dryer and brought to the desired blank size by turning and milling (e.g. 3 mm thickness, 12.7 mm diameter).

Transmission measurements show that with the aid of the ophthalmologic composition according to the invention, it is absorbed not only the UV portion (<400 nm), but also the entire violet light portion (400 nm to 430 nm). Ophthalmologic compositions on the market have a high light transmission in the violet range with a transmission up to one third. The composition according to the invention only shows a transmission of below 3% at 430 nm.

In the blue light range, for example, the composition according to the invention has a light transmission of above 70% at 460 nm, whereas the known lenses here only have a transmission of 50-60%.

The ophthalmologic composition is in particular suitable for visual aids such as glasses, contact lenses and eye implants. In particular, the ophthalmologic composition according to the invention is suitable for intraocular lenses.

According to the second aspect of the invention, a high degree of photoprotection with maximum photoreception at the same time is ensured by the ophthalmologic composition. Thus, this composition has to absorb substantially the entire ultraviolet spectral range and the violet light portion of the visible spectrum, but at the same time allow the complete transmission of blue light, in particular of the wavelength range between 450 nm and 500 nm.

Further features of the invention are apparent from the claims and the description. The features and feature combinations mentioned above in the description are usable not only in the respectively specified combination, but also in other combinations or alone without departing from the scope of the invention. The ophthalmologic composition or an advantageous implementation thereof can also have an implementation of the copolymer according to the invention.

1-43. (canceled)

44. A copolymer comprising:
a) 20 to 95 percent by weight, based on the total weight of the copolymer, of structural units derived from at least one hydrophilic monomer, and
b) 5 to 80 percent by weight, based on the total weight of the copolymer, of structural units derived from at least one monomer according to the general formula I 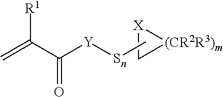
wherein
R¹, R² and R³ each independently of each other denote hydrogen or alkyl-,
Y: denotes O or NR⁴ with R⁴ selected from hydrogen or alkyl-,
X: denotes O, S, SO or SO₂,
S: denotes a structural unit selected from CHR⁵ or (CHR⁵CHR⁵O)ᵢCH₂, wherein all of the R⁵ each independently of each other denote hydrogen or alkyl-,
n and i independently of each other denote an integer between 1 and 10 and m denotes an integer between 2 and 6,
and wherein the copolymer has a water content from 1 to 59 percent by weight based on the total weight of the copolymer.

45. The copolymer according to claim 44, wherein the monomer b) has the following general structure

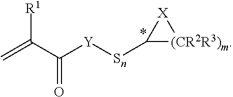

46. The copolymer according to claim 44, wherein 21 to 80 percent by weight, based on the total weight of the copolymer, of structural units are derived from at least one monomer according to the general formula I.

47. The copolymer according to claim 44, wherein the hydrophilic monomer a) is a monomer of the general formula II 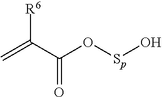
wherein
S: denotes a structural unit selected from CHR⁷ or (CHR⁷CHR⁷0)ₖCH₂, wherein all of the R⁷ each independently of each other denote hydrogen or alkyl- and p and k independently of each other denote an integer between 1 and 10.

48. The copolymer according to claim 44, wherein the hydrophilic monomer is hydroxyethyl methacrylate (HEMA) and/or hydroxypropyl methacrylate (HPMA) and/or glycerol monomethacrylate.

49. The copolymer according to claim 44, wherein the monomer of the general formula I is tetrahydrofurfuryl methacrylate (THFMA).

50. The copolymer according to claim 44, wherein the copolymer contains an UV absorber and/or a violet absorber (yellow dye).

51. The copolymer according to claim 44, wherein the copolymer contains one or more cross-linkers.

52. The copolymer according to claim 51, wherein at least a portion of the cross-linker or the cross-linkers is a violet absorber or an UV absorber.

53. The copolymer according to claim 44, wherein the copolymer has a refractive index of at least 1.3.

54. An ophthalmic lens including a copolymer according to claim 44.

55. The ophthalmic lens according to claim 54, wherein the lens is an intraocular lens and/or an ophthalmic implant.

56. The ophthalmic lens according to claim 54, wherein the ophthalmic lens is one-piece or multi-piece.

57. The ophthalmic lens according to claim 54, wherein the ophthalmic lens is foldable.

58. A method for producing an ophthalmic lens, an intraocular lens and/or an ophthalmic implant, the method comprising providing the copolymer according to claim 44.
